(19) United States
(12) Patent Application Publication
(10) Pub. No.: US 2021/0019366 A1
(43) Pub. Date: Jan. 21, 2021

(54) Text Extraction Heuristics

(71) Applicant: RELATIVITY ODA LLC, Chicago, IL (US)

(72) Inventors: Douglas Markey, Western Springs, IL (US); Karl Knoernschild, La Grange, IL (US); Joseph Keslin, Munster, IN (US)

(21) Appl. No.: 16/511,416

(22) Filed: Jul. 15, 2019

(51) Int. Cl. G06F 17/21; G06F 16/93; G06F 17/24; G06F 17/22

(52) U.S. Cl. CPC G06F 17/214; G06F 17/2217; G06F 17/24; G06F 16/93

(57) ABSTRACT

Systems and methods are described for facilitating reliable extraction of text content from particular classes of digital documents (e.g., PDF documents) having that lack the structural information traditionally necessary for straightforward text extraction. Font encoding patterns are identified as indicative of an offset that may be applied to code values in the font encoding to produce values of intended Unicode characters. By classifying a particular digital document according to these patterns, an offset may be identified and text may be extracted without requiring use of computationally intensive optical character recognition (OCR) techniques.

### FIELD

The present disclosure generally relates to digital font encoding and, more particularly, to techniques for extracting text content from particular classes of digital documents, such as PDF documents, having irregular font encoding structures.

### BACKGROUND

The Portable Document Format (PDF) is an electronic file format that enables digital presentation of electronic documents that may include text, images, videos, annotations, and/or other content. PDF is presently standardized and published by the International Organization for Standardization as ISO 32000-2, and allows for widespread, consistent implementation of the format across various electronic devices, operating systems, and software programs.

Certain digital documents, such as PDF documents, typically include a font object that describes characteristics of a font in which viewable text characters may be displayed in the document. The font object includes a collection of glyphs, each of which is a graphical representation of an abstract character. For example, a font may provide a particular glyph to graphically represent the uppercase of the third letter of the standard Latin alphabet (“C”). Each glyph in a particular font corresponds to a unique integer “glyph code” that identifies the glyph in the font. For example, in the well-known Arial font, a hexadecimal glyph code of 0x43 typically maps to a glyph for the uppercase letter “C”. The mapping in a font of a plurality of glyphs to respective glyph codes may be referred to as the font's “encoding.”

A rendering/viewer application (e.g., Adobe® Acrobat) may produce viewable text from a digital document based upon a “content stream” included in the digital document. For example, the application Adobe® Acrobat may produce viewable text based upon a PDF content stream. The content stream identifies glyph codes corresponding to glyphs to be “drawn” on a page, and other instructions defining where and/or how to draw those glyphs (e.g., coordinates, size, color, etc.). Although these instructions allow for glyphs to be displayed graphically on a page, the instructions do not necessarily define the text information content of the glyphs. In other words, this method of drawing glyphs on a page does not, in and of itself, identify the abstract characters themselves, as would be required to extract text content to support certain advanced processing such as searching, indexing, text-to-speech conversion, and exportation to other applications or file formats.

Computing industry standards have emerged for encoding of text characters expressed in various languages and writing systems. The particularly prevalent Unicode standard, for example, comprises unique hexadecimal character codes for over 130,000 characters, thereby providing a consistent character encoding scheme usable across various computing systems and applications. In many digital documents, fonts are encoded such that glyphs at respective glyph codes correspond directly to a portion of Unicode (e.g., the “standard Latin” code range) or to another well-known character encoding scheme. Alternatively, the document may contain additional data (e.g., a “ToUnicode” mapping) that matches the font's glyph codes to Unicode values (also known as “character codes” or “code points”). In either case, such structure of a document, when present, allows for straightforward extraction of text content. Still, though, there exist numerous classes of documents neither have such a “regular” font encoding scheme nor include the further information that would allow for straightforward extraction of text information content.

Conventionally, in these cases, optical character recognition (OCR) techniques may be used to extract text content from digital documents based upon analysis of graphical contours of the glyphs themselves. Although modern OCR techniques are known to accurately extract text content, they are also known to be computationally intensive. For this reason, OCR techniques may not easily be applied to large documents or at devices having certain limitations, such as limited processing power or battery capacity. Thus, for these numerous classes of problematic digital documents, there exists a lack of reasonable techniques for extracting text content.

### SUMMARY

This detailed description provides systems and methods for reliable computerized extraction of text content from particular classes of PDF documents having fonts that lack the font encoding and/or mapping information that would ordinarily allow for straightforward extraction of text content. Certain patterns are identified in font encodings which are found to be “offset” by a consistent amount from corresponding Unicode character codes. At a high level, the techniques described herein include determining particular characteristics of glyphs encoded at particular glyph codes in a font object included in a PDF document, to determine whether the font encoding exhibits the patterns that suggest applicability of an offset to the font encoding.

When an offset is identified, adding the offset to each glyph code in the font encoding produces a respective “sum value” that corresponds to the intended Unicode character being represented by a glyph at the glyph code. Using these techniques, text content may be accurately extracted from digital documents lacking traditional font encoding information, without requiring the use of computationally intensive OCR techniques.

In an embodiment, a computer-implemented method may be provided, the computer-implemented method facilitating text content extraction from a digital document (e.g., a PDF). The method may include (1) identifying, via one or more processors, a font object corresponding to a content stream of a digital document, the font object comprising a font encoding of a plurality of glyph codes to a respective plurality of glyphs, (2) determining, via the one or more processors, one or more characteristics of one or more glyphs of the font object, the one or more characteristics excluding text information content of the one or more glyphs, and/or (3) determining, via the one or more processors based upon the one or more determined glyph characteristics, an integer offset associated with the font encoding, wherein, for each particular glyph code of the plurality of glyph codes in the font encoding, adding the integer offset to the particular glyph code produces a respective sum value corresponding to a respective Unicode character, the Unicode character being a character represented by the glyph encoded at the particular glyph code of the font encoding. The method may include additional, fewer, and/or alternate actions, including those described herein.

In another embodiment, a computing system may be provided, the computing system configured to facilitate text content extraction from a digital document (e.g., a PDF). The system may include one or more processors and one or more non-transitory computer memories storing computer-executable instructions that, when executed via the one or more processors, cause the one or more processors to (1) identify a font object corresponding to a content stream of a digital document, the font object comprising a font encoding of a plurality of glyph codes to a respective plurality of glyphs, (2) determine one or more characteristics of one or more glyphs of the font object, the one or more characteristics excluding text information content of the one or more glyphs, and/or (3) determine, based upon the one or more determined characteristics of the one or more glyphs, an integer offset associated with the font encoding, wherein, for each particular glyph code of the plurality of glyph codes in the font encoding, adding the integer offset to the particular glyph code produces a respective sum value corresponding to a respective Unicode character, the Unicode character being a character represented by the glyph encoded at the particular glyph code of the font encoding. The system may include additional, fewer, and/or alternate computing entities, and/or may be configured to perform additional, fewer, and/or alternate actions, including those described herein.

In yet another embodiment, one or more non-transitory computer readable media may be provided. The one or more non-transitory computer-readable media may store computer-executable instructions that, when executed via a computer, cause the computer to (1) identify a font object corresponding to a content stream of a digital document, the font object comprising a font encoding of a plurality of glyph codes to a respective plurality of glyphs, (2) determine one or more characteristics of one or more glyphs of the font object, the one or more characteristics excluding text information content of the one or more glyphs, and/or (3) determine, based upon the one or more determined characteristics of the one or more glyphs, an integer offset associated with the font encoding, wherein, for each particular glyph code of the plurality of glyph codes in the font encoding, adding the integer offset to the particular glyph code produces a respective sum value corresponding to a respective Unicode character, the Unicode character being a character represented by the glyph encoded at the particular glyph code of the font encoding. The one or more non-transitory computer-readable media may store additional, fewer, and/or alternate instructions, including those described herein.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed embodiments, and explain various principles and advantages of those embodiments.

FIG. 1 depicts examples of glyphs provided in different fonts to represent a same “abstract” character;

FIG. 2 depicts an example partial set of glyphs and corresponding glyph codes in a particular font;

FIGS. 3A and 3B depict example addition of offset to hexadecimal glyph codes, the addition of the offset producing sum values that correspond to intended Unicode characters;

FIGS. 4A-4C depict example computer-implemented methods for determining an offset to be applied to glyph codes in a font encoding, and for applying the offset to produce sum values corresponding to intended Unicode characters;

FIG. 5 depicts example classification of “packing” of a range of glyph codes; and

FIG. 6 depicts an example computing environment for implementation of the techniques described herein.

### DETAILED DESCRIPTION

At a high level, this detailed description provides systems and methods for reliable computerized extraction of text content from particular classes of digital file formats which lack the font encoding information that would traditionally allow for straightforward text content extraction, and in which optical character recognition (OCR) techniques may otherwise be required for extraction of the text content. In numerous embodiments, the systems and methods described herein may be applied to documents in the Portable Document Format (“PDF documents”). Although the following description will describe the systems and methods being applied to the PDF file format, it should be appreciated that the at least some of the systems and methods may be applied to additional and alternative file formats, in some embodiments.

Certain patterns are identified as consistently present in font encodings in which glyph codes are “offset” from intended Unicode character codes by a fixed, consistent amount. In other words, where a font encodes a particular glyph at a particular glyph code, adding the offset to the glyph code produces a sum value that encodes a particular character in Unicode, with that particular character being the abstract character most corresponding to the glyph at the original glyph code.

A font object of a PDF document may be analyzed with respect to these patterns. Particularly, one or more characteristics of one or more glyphs encoded at particular glyph codes in a font encoding may be determined. Based upon the determined one or more characteristics, it may be determined whether the font encoding follows the patterns of font encodings to which an offset may be appropriately applied. When an offset is applicable, the offset may be added to each glyph code in the font encoding to produce a sum value that corresponds to an intended Unicode character. Thus, text meaning of glyphs may be determined and text content may be reliably be extracted from the PDF document. These techniques may allow for advanced processing of the PDF document (e.g., searching, indexing, text-to-speech conversion, etc.), without requiring OCR analysis of the PDF document.

Generally, computing actions described herein may be performed via one or more computing devices, such as a desktop computer, a laptop computer, a server, smartphone, a personal digital assistant (PDA), a tablet computing device, another computing device, or any suitable combination thereof. In some embodiments, a computing device may include one or more non-transitory computer memories storing computer-executable instructions that, when executed via one or more computer processors, cause the one or more processors to perform computing actions described herein. Additionally or alternatively, in some embodiments, one or more computer-readable media may include computer-executable instructions that, when executed via one or more computing devices, cause the one or more computing devices to perform computing actions described herein. Further examples of example computing methods and environments will be provided herein.

### Background and Problem Description

Viewable text in a PDF rendering/viewer application (e.g., Adobe® Acrobat) typically corresponds to a set of “glyphs.” each of which defines a set of contours to be “drawn” on a page to thereby graphically represent a particular abstract character. Collections of glyphs or “fonts” (e.g., Arial) include glyphs to represent each character in a character set (e.g., a collection of glyphs to represent letters of the standard Latin alphabet).

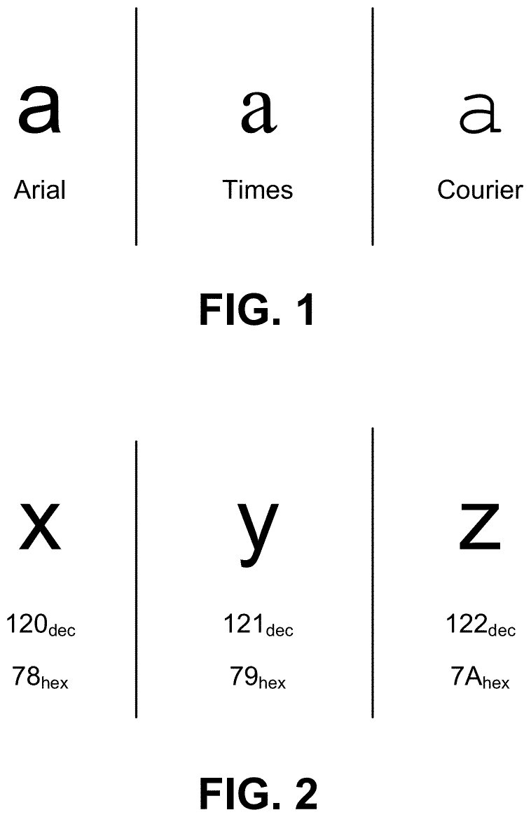

FIG. 1 depicts a glyph in each of the common fonts Arial (“Arial”), Times New Roman, and Courier New. The glyph in each font is used to represent a same character, i.e., the lowercase of the first character in the standard Latin alphabet (“a”). Each of the glyphs defines a different set of contours to represent the “a” character, in accordance with stylistic tendencies their respective fonts.

Within a particular font, each glyph is associated with a unique integer “glyph code.” FIG. 2 depicts three glyphs from the Arial font, the depicted glyphs representing the lowercase of the final three characters in the standard Latin alphabet (“x”, “y”, “z”). Listed below each glyph is the glyph code corresponding to the respective glyph. The glyph codes are provided both in decimal notation and hexadecimal notation, with hexadecimal notation being used hereinafter unless specifically indicated otherwise. For example, the glyph for “x” in the Arial font corresponds to a glyph code that may be represented in decimal notation as 120 (“120_{dec}”), or equivalently represented in hexadecimal notation as 78 (“78ₕₑₓ”, alternatively “0x78”). Additional glyphs are provided in the Arial font and other fonts to represent characters of the Latin alphabet, as well as various punctuation characters, symbols, mathematical operators, etc. In any font, the mapping of unique integer glyph codes to glyphs may be referred to as the font's “encoding.”

A PDF document typically includes a “content stream” from which readable text among other content is produced. The content stream may include one or more “text elements,” with the text element specifying (1) the font to be used, (2) the glyphs, identified by glyph codes, to be drawn on a page, and/or (3) position, size, or other characteristics according to which glyphs are to be drawn. The PDF document further includes one or more “font objects,” each of which includes a font encoding. Thus, to produce viewable text on a page, a PDF rendering/viewer application typically (1) reads a text element of a content stream including an identified font and a set of glyph codes, (2) references the font encoding of a corresponding font object to identify the glyph(s) corresponding to the set of glyph codes, and (3) draws the identified glyphs according to the position, size, and/or other parameters set forth in the content stream.

Notably, the techniques described above do not necessarily produce the actual information content (“text content”) of the displayed text. That is, in a computing context, glyphs and hence glyph codes are not always associated with their intended “meaning.” While a literate human reader may easily identify standard Latin characters represented by glyphs (e.g., the glyphs in FIG. 2) a PDF rendering/viewer application does not necessarily identify the characters represented by the glyphs when drawing glyphs on a page.

Many PDF documents include sufficient information such that standard characters (and thus text content) may easily be extracted from the PDF document. In many PDF documents, a font encoding may appropriately correspond to a well-defined character set, such as a portion of characters in Unicode Version 11.0.0. For example, in the Arial font as depicted in FIG. 2, the glyph codes for the three depicted Arial glyphs correspond directly to a same Unicode character code or “code point” for three Latin characters “x”, “y”, and “z”, which are represented in hexadecimal Unicode notation as U+0078, U+0079, and U+007A, respectively. Likewise, each of the three fonts depicted in FIG. 1 may encode the “a” glyph at a glyph code 0x61, which would correspond directly to the Unicode code point for the Latin character “a” (U+0061). Such well-defined fonts may include information specifically indicating a “standard encoding” that may correspond directly to a portion of the Unicode character space (or to another well-defined character set such as ASCII or MacRoman).

Not all font encodings correspond directly to a well-defined character set such as Unicode. Some irregular font encodings may not correspond directly to a well-defined character set, but include further structural information (e.g., a “ToUnicode” map) that indicates font glyph codes as corresponding to respective code points in a well-defined character set. For example, a font may encode a glyph “z” at a hexadecimal glyph code 0x9B, but a ToUnicode map of the font may indicate that the glyph at glyph code 0x9B corresponds to the Unicode character code U+007A. Thus, even when a content stream of a PDF document references a font with such “irregular” encoding, further mapping information may preserve the ability to identify text content of the PDF document.

Many classes of PDF documents, however, include font objects with encodings that neither correspond directly to a well-defined character set nor provide supplementary structural information as described above. While PDF rendering/viewer applications may still display glyphs from these PDF documents, the text content thereof may not be available unless optical character recognition (OCR) techniques are applied to the glyphs. OCR techniques, though accurate in identification of text content, are computationally intensive and thus may not be easily and automatically applied to large PDF documents, or to large collections of PDF documents.

### Encoding Correction Using Offset to Unicode

The problem of text extraction from PDF documents having irregular font encodings has emerged due at least in part to the presence of a vast set of different electronic tools and techniques for generating PDF documents. Examining font encoding within some of these PDF documents, patterns are identified in font encodings in which glyph codes are offset from code points of intended Unicode characters by a consistent integer amount. That is, for each original glyph code in the font's plurality of glyph codes (referred to herein as a “code space”), adding a particular “offset” value to the original glyph code produces a sum value that corresponds directly to a character code of an intended Unicode character. In one identified class of PDF documents, the offset has a hexadecimal value of 0x1D. In another identified class of PDF documents, the offset has a hexadecimal value of 0x1E.

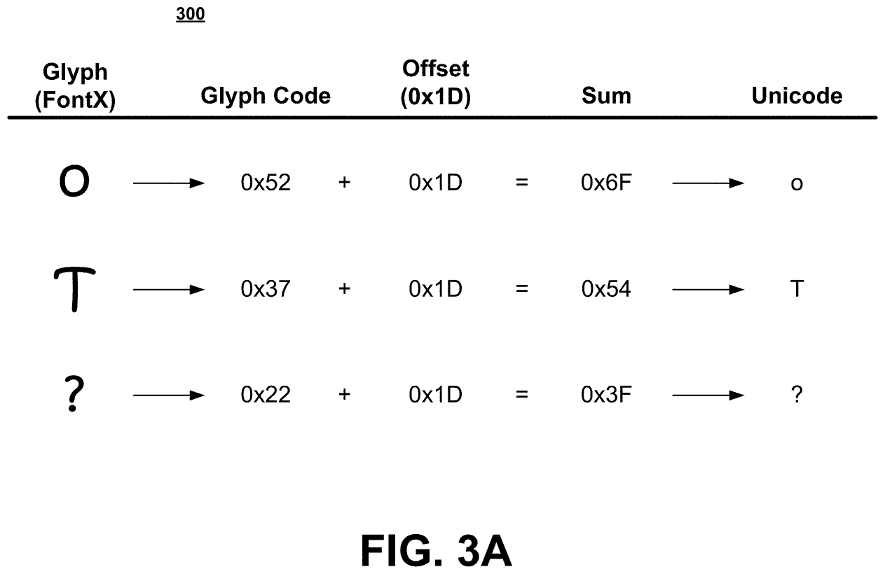

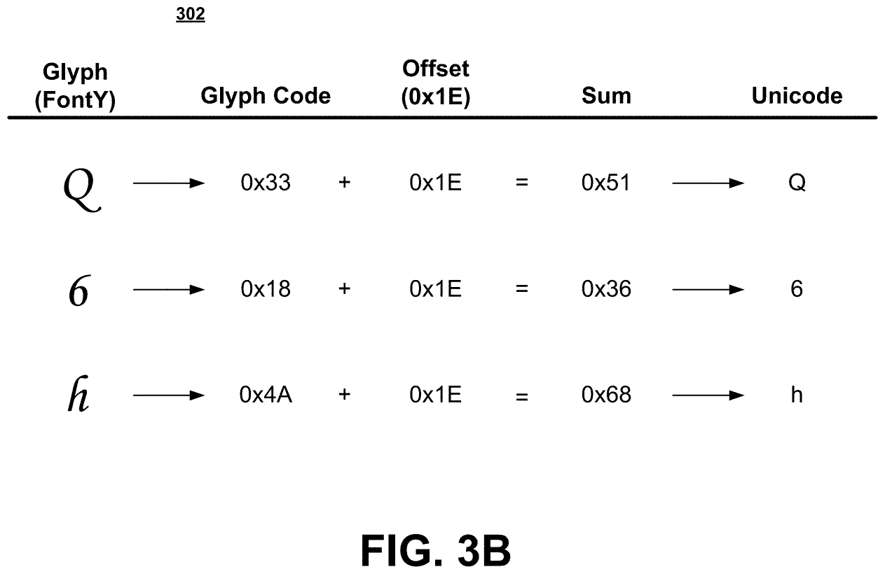

FIGS. 3A and 3B provide examples of irregular font encodings including glyph codes that may be mapped to proper Unicode characters using the 0x1D or 0x1E offset. The mathematical offset calculations themselves will be described with respect to FIGS. 3A and 3B, and subsequent description will describe computing methods and systems for determining whether any particular font encoding exhibits the patterns that suggest that either the 0x1D or 0x1E offset may be appropriately applied to extract text content from a PDF document.

First referring to FIG. 3A, a table 300 depicts a mapping of three example glyphs to appropriate Unicode characters using a 0x1D offset. The left-most column “Glyph (FontX)” visually depicts the three example glyphs from a font “FontX” which may correspond to a font object included in a PDF document. In the font encoding of example font FontX, the three glyphs correspond, respectively, to hexadecimal glyph codes 0x52, 0x37, and 0x22.

To allow the glyphs to be drawn on a page, the PDF document includes a content stream indicating the FontX to be used to draw the glyphs, the glyphs being indicated in the content stream by their unique glyph codes. Although a literate human reader may recognize the characters represented by these glyphs (standard Latin lowercase “o,” uppercase “T,” and question mark) once displayed on a page, the PDF document may lack the digital structural information necessary to digitally extract the text content (i.e., the actual characters) from the content stream. That is, the encoding of FontX may not correspond directly to Unicode nor to any other well-defined character set, and no further structural information may be included in the PDF document that would map the FontX glyph codes to such a well-defined character set.

In this example scenario, patterns may be identified in the encoding of FontX that indicate that adding the 0x1D offset to each glyph code in FontX produces a “sum value” that corresponds directly to an intended character in Unicode. The table 300 provides examples of hexadecimal addition using the FontX glyph codes and the offset 0x1D. For example, adding the offset 0x1D to the “o” glyph code 0x52 produces a sum value of 0x6F. The sum value 0x6F is typically expressed in hexadecimal Unicode notation as “U+006F,” and this value in Unicode corresponds to the Latin character “o”. Thus, adding the 0x1D offset to the glyph code for the “o” glyph produces the sum value corresponding to the Unicode character that the glyph intends to represent. The same offset addition may be applied to each glyph code in the FontX code space.

Now referring to FIG. 3B, another table 302 depicts a mapping of three example glyphs of a font FontY to intended Unicode characters using a 0x1E offset. The table 302 includes three example glyphs from a font FontY, in which patterns may be identified that indicate that adding the 0x1E offset to glyph codes produces respective sum values corresponding to intended Unicode characters. Thus, for each glyph code for the plurality of glyph codes in FontY, the offset 0x1E may be added to the glyph code to produce a sum value that, in Unicode notation, represents an intended character (Latin character “0”, number “6”, and Latin character “h”).

Using the techniques described herein, characteristics of font encodings in PDF documents may be analyzed to determine whether an offset 0x1D or 0x1E may appropriately be applied to the font encoding as described above to produce intended Unicode characters, and hence text content. In some embodiments, an offset may be applied to produce sum values corresponding to Unicode characters, and an additional mapping object may be constructed, the mapping object defining correspondence of original (unaltered) glyph codes to the sum values that correspond to Unicode characters. The mapping object may be added to the existing PDF document (and/or other similar PDF documents), thus adding digital structure that provides for reliable extraction of text content from a PDF document, without altering the original content stream or font encoding structure itself.

Alternatively, in some embodiments, an appropriate offset 0x1D or 0x1E may be applied and saved to the font encoding and the content stream in a PDF document (and/or other similar PDF documents). That is, the original content of the PDF document may be modified such that instances of glyph codes in both the text element of the content stream and corresponding font encoding are modified via the offset, thereby reformatting the PDF document to include a font encoding that corresponds directly to Unicode.

In either case, in some embodiments, text content may be extracted from the PDF document, and one or more objects may be added to the PDF document defining the literal text content in the PDF document.

In any case, these offset techniques allow for reliable computerized extraction of text content from one or more PDF documents using existing font encoding information and without requiring use of OCR techniques. Moreover, as should be clear from this detailed description, these offset techniques allow for application of an appropriate offset and/or extraction of text content from a PDF document without necessarily requiring use of a PDF rendering/viewer application to access, open, or display the PDF document. Thus, the offset techniques described herein may be implemented in a variety of suitable computing environments, independent of the presence of a dedicated PDF rendering/viewer application (e.g., Adobe® Acrobat) at a device performing these techniques.

### Example Computer-Implemented Method for Pdf Text Extraction

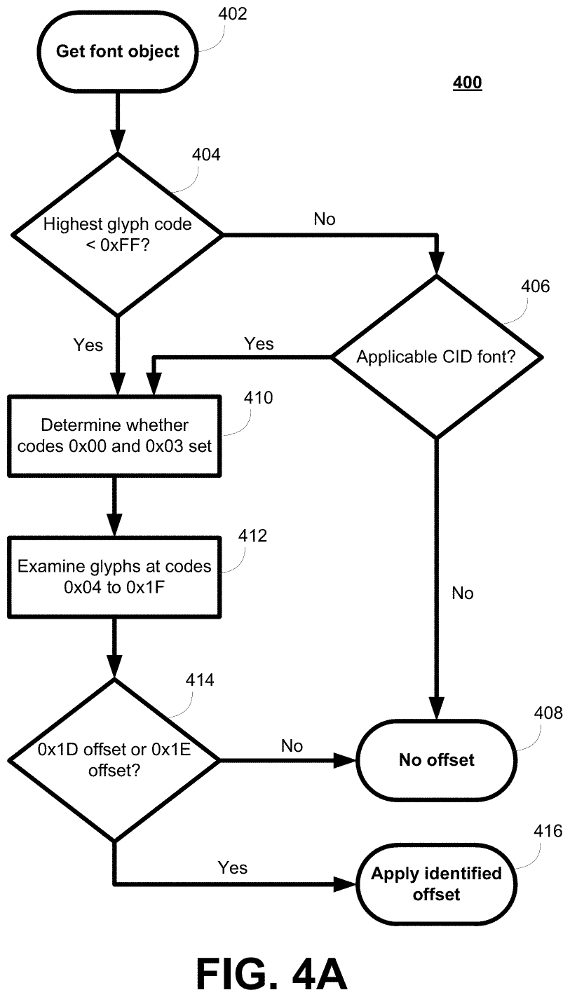

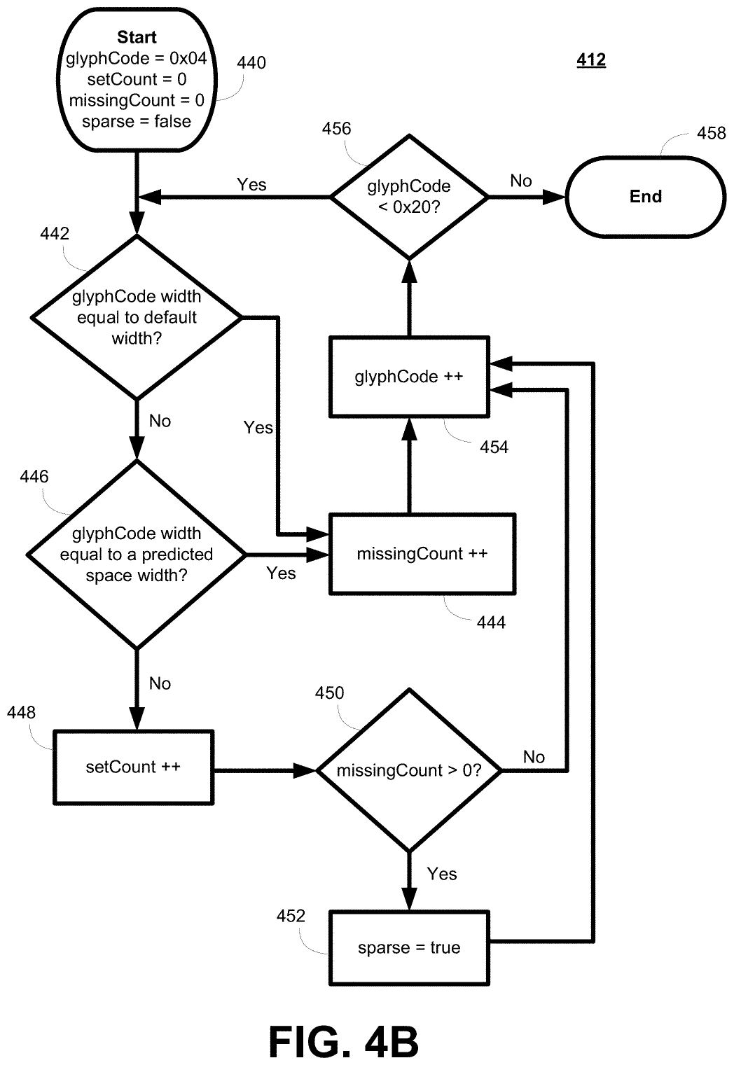

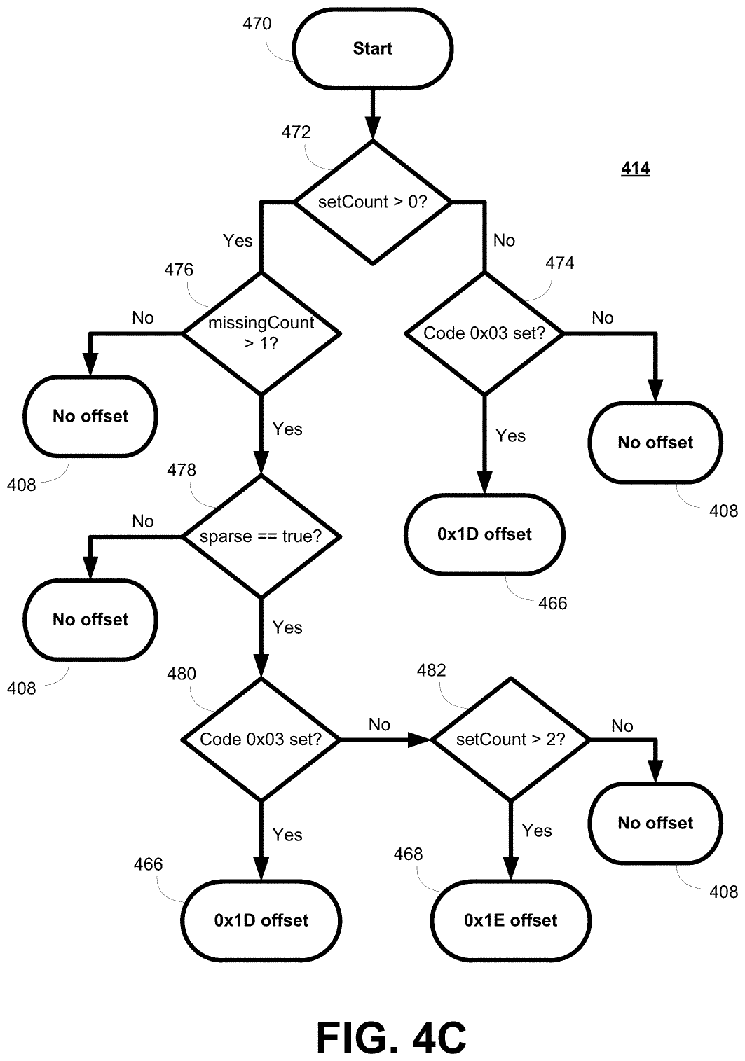

FIGS. 4A-4C depicts an example computer-implemented method 400 for determining applicability of an offset to a font encoding to produce intended Unicode characters, and for extraction of text content from a PDF document (or other digital document) using the offset. Although the following description will describe text content extraction from a PDF document, it should be appreciated that the following method(s) may be applied to additional and alternative file formats, in some embodiments.

More particularly, the computer-implemented method 400 may include analyzing particular characteristics of a font encoding to determine whether the encoding follows patterns (“indicators”) that are found to indicate whether the 0x1D or 0x1E offset may be appropriately applied to produce values of intended Unicode characters (i.e., code points of corresponding Unicode characters). These indicators relate, for example, to (1) the highest character code in the font object, (2) the presence of “set” or “defined” glyph at a particular glyph code or range of codes, (3) the width of glyphs at particular glyph codes, and/or (4) the presence of “gaps” between set glyph codes (“sparseness”). Where these and/or indicators are present in a font encoding, it may be determined that (1) an 0x1D offset is applicable to the font encoding, (2) a 0x1E offset is applicable to the font encoding, or (3) neither the 0x1D offset nor the 0x1E offset is applicable (“no offset”), and any application of either the 0x1D or 0x1E may in fact regress another correct solution.

As will be evident from description of the method 400, actions of the method 400 do not assume or require any pre-existing knowledge of the text content of a PDF document. Rather, the method 400 includes analyzing other characteristics of glyphs/glyph codes, such that text content may be extracted from PDF documents and/or other digital documents having previously unknown text content.

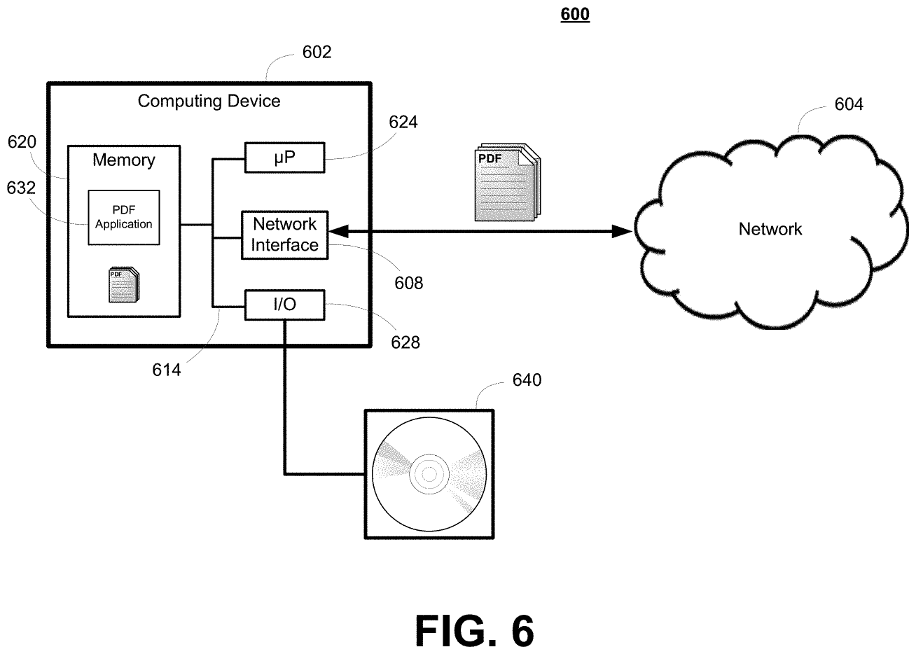

In some embodiments, actions of the computer-implemented method 400 may be performed via one or more computing elements to be described with respect to FIG. 6. In some embodiments, for example, a computing device may comprise one or more computer-readable memories storing computer-executable instructions that, when executed, cause one or more computer processors to perform one or more actions of the method 400. Additionally or alternatively, one or more computer-readable media may store computer-executable instructions that, when executed via a computer, cause the computer to perform one or more actions of the method 400.

First referring to FIG. 4A, the method 400 may include identifying a font object, which may be a font object from a PDF document. The font object may correspond to a font identified within a text element in a content stream of the PDF document, the content stream including glyph codes corresponding to the font object's encoding.

The method 400 may include determining whether the highest glyph code in the font object is less than a hexadecimal value of 0xFF (404, i.e., whether the highest glyph codes is within a range of 0x00 to 0xFE). In other words, it may be determined whether the code range of the font encoding is contained within hexadecimal codes 0x00 to 0x1E (0 to 254 in decimal notation). This determination effectively excludes fonts that require more than a one-byte memory allocation to each glyph code.

If the highest glyph code is not less than 0xFF (i.e., greater than or equal to 0xFF), the method 400 may further include determining whether the font object is of a particular class of CID-keyed font objects to which the offset techniques herein may still apply, even when the condition of action 404 is satisfied (406). More particularly, the action 406 may include determining whether the font-object is a CID-keyed font having glyph width tables comprising a particular distinct glyph widths. While the presence of only a single glyph width may indicate that corresponding glyphs are not defined, that is, set to either the default glyph width or the space width (i.e., each glyph having one of those two widths). On the other hand, a CID-keyed font object width table including three or more different glyph widths may indicate that one of the offsets may in fact be applicable to the font object (action 406: yes).

If neither of condition of action 404 nor the condition of action 406 is satisfied (i.e., if the highest glyph code is not less than 0xFF, and the font is not an applicable CID-keyed font), it may be determined that neither the 0x1D offset nor the 0x1E offset is applicable to the font object (408, “No offset”). That is, application of either offset to each glyph code in the font object would not produce sum values corresponding to intended Unicode characters, and may instead regress another correct solution.

If the conditions of either actions 404 or 406 are satisfied (i.e., the font has a highest glyph code less than 0xFF, or the font is an applicable CID-keyed font), the method 400 may include determining whether glyph codes 0x00 and 0x03 of the font object are “set” (410). As used herein, “set” glyph codes (or “set glyphs”) generally refer to glyph codes at which a glyph is defined in a font encoding. Accordingly, an “unset” or “undefined” glyph code generally (or “undefined glyph”) refers to a glyph code and corresponding glyph that amounts to empty space in a font encoding.

Determining whether a glyph code is “set” generally includes determining the graphical width of the glyph defined at the glyph code, and comparing the glyph width to a “default width” value assigned by default to undefined glyph codes in the font. A determination that width of a glyph at a particular glyph code is equal to the default width may suggest that the particular glyph code is undefined. Conversely, a determination that the width of a glyph at a particular glyph code differs from the default width may suggest that the particular glyph code is set (e.g., set as a glyph to represent a particular letter, number, symbol, control character, etc.).

Accordingly, action 410 may include determining whether glyph code 0x00 is set, based upon a determination of whether the width of the glyph encoded at glyph code 0x00 differs from the determined default width. Action 410 may further include determining whether glyph code 0x03 is set, based upon a determination of whether the width of the glyph encoded at glyph code 0x03 differs from the default width.

Furthermore, from patterns which are observed in the many of the PDF documents addressed by this detailed description, the status of code 0x00 as “set” may indicate that code 0x03 is set as a “space” character. Accordingly, in some embodiments, action 410 may include, if code 0x00 is set, determining that the glyph at code 0x03 represents a “space” character. In these scenarios, the width of the glyph at code 0x03 may be referred to as a “predicted space width,” the significance of which will be further evident later in this description of the method 400.

In any outcome of action 410, the method 400 may further include, subsequent to examining codes 0x00 and 0x03, examining respective glyphs at each of glyph codes 0x04 to 0x1F (412). Examining the glyphs at codes 0x04 to 0x1F may generally include determining, for each glyph code, whether or not the glyph code is “set” or “undefined.”

More particularly, example sub-actions of action 412 are visually depicted in FIG. 4B. Actions of FIG. 4B may be understood as a programmed loop, in which glyphs at glyph codes form 0x04 to 0x1F are examined incrementally via other sub-actions of FIG. 4B. In some embodiments, action 412 may be implemented via such a loop.

At a start of action 412, a variable “glyphCode” may represent a hexadecimal value of a glyph code to be examined, and may be initialized at 0x04 (440). An integer counter variable “setCount” may be initialized at zero, and may be used to count the number of “set” glyph codes in the 0x04 to 0x1F code range of the font encoding. Another integer counter variable “missingCount” may be used to count the number of “missing” (or generally, “undefined”) glyph codes in the same 0x04 to 0x1F code range of the font encoding. A Boolean variable “sparse,” of which the significance will be expanded upon herein, may be initialized as false.

Action 412 may include determining whether the width of the glyph at glyphCode (e.g., the glyph encoded at glyph code 0x04) is equal to the default width of the font (442). If the width of the glyph matches the default width, the glyph code is referred to as “undefined” (hence, “missing”) and thus missingCount is incremented by one (444). In FIG. 4B, incrementing of any given value by one may be represented as “value++”.

If the width of the glyph does not match the default width, it is not additionally determined that the glyph code is “missing.” Instead, an additional determination may be made of whether the width of the glyph at glyphCode matches a predicted space width. The predicted space width, as described above with respect to action 410, is the width of the glyph at code 0x03 when glyph code 0x00 present when code 0x00 is set. If code 0x00 is not set, then no predicted space width is present, and thus the width of the glyph at glyphCode cannot match a predicted space width. Effectively, action 446 may produce a positive determination if code 0x00 is set and the width of the glyphs encoded at 0x03 and glyphCode are equal. In this implementation, duplicate space glyph codes, i.e., glyph codes which define a space character already defined at code 0x03, are counted as “missing.”

Accordingly, if the condition of action 446 is satisfied, missingCount is incremented by one (444). If the condition of action 442 was not satisfied and the condition of action 444 was not satisfied, it may be determined that glyphCode is “set” (i.e., not missing), and thus setCount may be incremented by one (448).

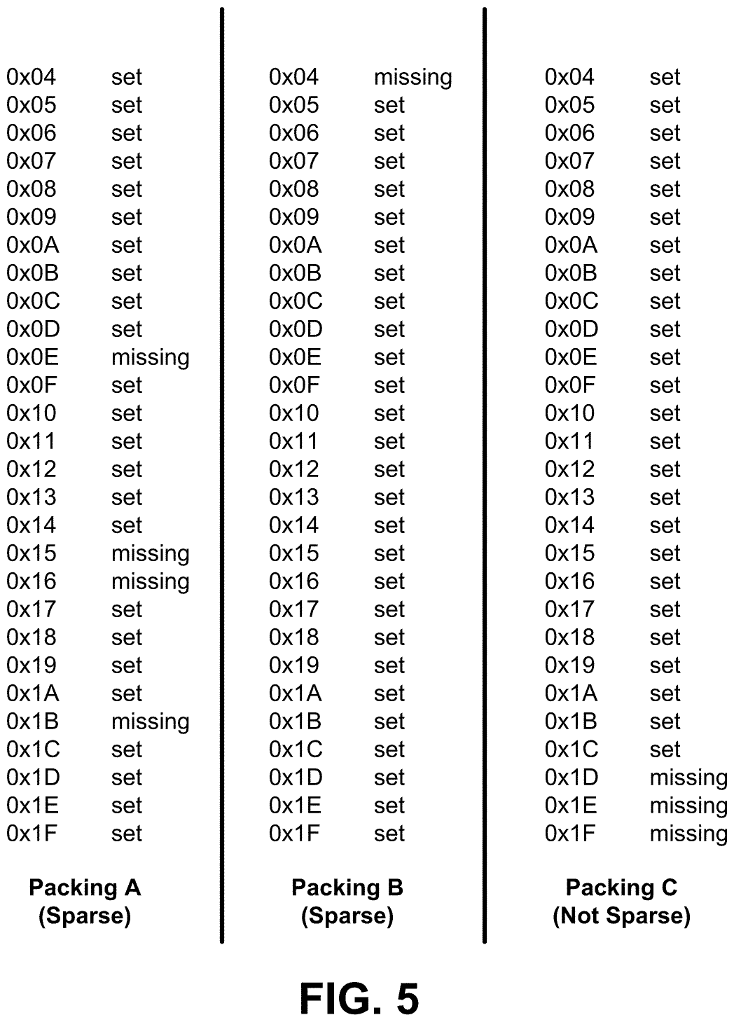

When glyphCode is identified as set and setCount is incremented, a determination may be made regarding the “packing” of the glyph code range thus far examined in action 412. “Packing,” as used herein, refers to a degree of usage of a code range, and is referred to as “sparse” when one or more “missing” glyph codes (“gaps”) are present prior to the end of the code range. Conversely, a packing is considered “not sparse” when no such gaps exist. Packing and sparseness may be better understood with reference to FIG. 5, which depicts three example “packings” of the glyph code range 0x04 to 0x1F.

As shown in FIG. 5, example Packing A of code range 0x04 to 0x1F is considered sparse based upon the presence of one or more “gaps” in the code range 0x04 to 0x1F. Missing glyph codes occur at 0x0E, 0x15 to 0x16, and 0x1 B, implying a lack of full usage of the code range 0x04 to 0x1F. Packing B of code range 0x04 to 0x1F is also considered sparse due to the presence of a “missing” glyph code at 0x04, which is prior to the end of the code range at 0x1F.

The packing of code range 0x04 to 0x1F according to Packing C, on the other hand, is not considered sparse. Although “missing” glyph codes occur at 0x1D to 0x1F, these glyph codes occur at the end of the code range 0x04 to 0x1F, and thus the usage of this code range is not considered sparse. Rather, it may be the case that no more glyphs remain needing to be defined in this code range, and thus the presence of “missing” codes is not an indicator of sparseness but instead the end of a font encoding.

Returning to FIG. 4B, when setCount is incremented (448), sparseness may be determined based upon a determination is made of whether missingCount is greater than zero (450). The condition of action 450 is satisfied when the current glyphCode is set and at least one previous glyph code has been identified as “missing,” thus implying a gap in the examined code range. For example, if the examined code range were the code range 0x04 to 0x1F according to Packing A in FIG. 5, the condition of action 450 may be satisfied when 0x0F is set and 0x0E has already been identified as missing. Accordingly, at action 450, if missingCount is greater than zero, sparseness of the code range is detected, and the Boolean variable “sparse” may be set to true, and will remain as such throughout action 412.

Subsequent to performance of actions 450 and/or 452, glyphCode may be incremented by one (454). After the incrementing of glyphCode, a determination may be made to whether glyphCode is less than 0x20 (i.e., 0x1F or less). If the incremented glyphCode is equal to 0x20, examination of the code range 0x04 and 0x1F has been completed, and action 412 may conclude (458). If glyphCode remains less than 0x20, action 412 may continue by repeating the actions described above (e.g., sub-action 442 and other appropriate actions) for the next glyph code in the code range (e.g., 0x05, followed by 0x06, 0x07, etc.). Completion of action 412 thus produces determinations of (1) a count of set glyph codes in the code range 0x04 to 0x1F (setCount), (2), a count of “missing” glyph codes in the code range 0x04 to 0x1F (missingCount), and (3) whether the packing of the code range 0x00 to 0x1F is sparse or not sparse (“sparse”).

Returning to FIG. 4A, upon completion of action 412, action 414 may include determining whether to apply either the 0x1D or 0x1E offset to the font encoding to produce values corresponding to intended Unicode characters. If action 414 produces a determination that either the 0x1D or 0x1E offset is applicable, the proper offset may be applied to the font encoding (416). Conversely, if action 414 produces a determination that neither the 0x1D offset nor the 0x1E offset is applicable, neither offset is applied (408).

FIG. 4C provides an expanded view of action 414, including sub-actions which may be included in action 414. Generally, action 414 includes determining, based upon previously determined characteristics of the font encoding (e.g., actions 404 through 412), whether the font encoding follows such patterns that indicate that (1) the offset 0x1D may be applied to glyph codes in the font encoding to produce sum values corresponding to intended Unicode characters (466), (2) a determination that the offset 0x1E may be applied to glyph codes in the font encoding to produce sum values corresponding to intended Unicode characters (468), or (3) a determination that neither offset should be applied (408). Action 414 may start (470) in response to completion of the actions of the loop depicted in FIG. 4B, in some embodiments.

Action 414 may include determining whether setCount is greater than zero (472). If setCount is equal to zero (that is, condition of action 472 is not satisfied), action 414 may further include determining code 0x03 is set (474). If code 0x03 is set, it may be determined that the 0x1D offset may be applied (466), and action 414 may conclude. If code 0x03 is not set (e.g. undefined), it may be determined that no offset should be applied (408), and action 414 may conclude.

If, at action 472, it is determined that setCount is greater than zero (i.e., at least one glyph code from 0x04 to 0x1F is set), action 414 may further include determining whether missingCount is greater than one (476). If missingCount is not greater than one (i.e., zero or one) it may be determined that no offset should be applied (408), and action 414 may conclude.

If, at action 476, it is determined that missingCount is greater than one, action 414 may further include determining whether the packing of code range 0x04 to 0x1F is sparse (478). If the packing is not sparse, it may be determined that no offset should be applied (408), and action 414 may conclude.

If, at action 478, it is determined that the packing of code range 0x04 to 0x1F is sparse, action 414 may still further include determining whether code 0x03 is set (480). If code 0x03 is set, it may be determined that the 0x1D offset may be applied (466), and action 414 may conclude.

If, at action 480, it is determined that code 0x03 is not set, action 414 may still further include determining whether setCount is greater than two. If setCount is greater than two, it may be determined that the 0x1E offset may be applied (468). If setCount is less than or equal to two, it is determined that no offset should be applied (480). In either case, action 414 may conclude.

Action 414 thus may produce a determination of whether a 0x1D or 0x1E offset may be applied to a font encoding. In some embodiments, upon determination of an applicable 0x1D or 0x1E offset, one or more flag variables may be modified within the font object and/or elsewhere in the PDF document, such that a font object may be “marked” for application of the appropriate offset using any of the suitable techniques described herein.

Furthermore, in some embodiments, if action 414 produces a determination that no offset should be applied (408), one or more additional actions may be performed. Particularly, determinations may be made of (1) whether setCount is greater than one, and (2) whether the packing of the code range 0x04 to 0x1F is not sparse. Effectively, if both conditions are satisfied (i.e., setCount >1 and sparse==false), the font object may be referred to as “tightly packed.” A tightly packed font may be indicative of a PDF document in which glyphs were simply coded sequentially in the order in which they were first used on a page of the PDF document, may be a font in which glyphs were encoded sequentially in the order in which they were used on a page of a PDF document, and thus are not likely to follow an approach where each glyph code is offset by a same amount (e.g., 0x1D or 0x1E) from corresponding Unicode characters. In other words, the offset techniques described herein may rarely be applicable to tightly packed fonts.

Returning to FIG. 4A, after conclusion of action 414, the method 400 may continue according to determination produced via action 414. If it is determined that neither the 0x1D offset nor the 0x1E offset is applicable to the font object in the PDF document, no offset may be applied (408), and the method 400 may conclude. If it is determined that either the 0x1E offset or the 0x1E offset may be applied to produce values corresponding to intended Unicode characters, the appropriate offset 0x1D or 0x1E may be applied (416).

In some embodiments, applying an offset may include adding the appropriate offset 0x1D or 0x1E to each glyph code in the font encoding in the font to produce respective sum values corresponding to intended Unicode characters, and an additional mapping object may be constructed, the mapping object defining correspondence of original (unaltered) glyph codes to the sum values that correspond to intended Unicode characters. In some embodiments, the mapping object may be added to the existing PDF document (e.g., to the font object) thus adding digital structure that provides for determination of text content, without altering original data from the existing PDF document.

Alternatively, in some embodiments, an appropriate offset 0x1D or 0x1E may be applied and save to both the font encoding and to the content stream of the PDF document. That is, the original content of the PDF document may be altered such that instances of glyph codes in both the text element of the content stream and in the corresponding font encoding are modified using the offset. The original formatting of the PDF document may thus be modified such that glyph codes correspond directly to intended Unicode values.

In any case, method 400 may include extracting text content from the PDF document, and in some embodiments, may further include adding one or more additional objects to the PDF document defining the text content of the PDF document, thereby allowing for searching, indexing, text-to-speech conversion, etc.

In some scenarios, a single PDF document may include two or more fonts. For example, a PDF document may include two or more font objects, and the content stream may comprise two or more text elements. Each text element may identify a different font to be used to draw glyphs (identified by glyph codes) at positions on a page. In these scenarios, actions of the method 400 may be performed separately and independently with respect to at least one of each of the two or more font objects in the PDF document. For example, the method 400 may be performed with respect to two font objects to apply an offset to glyph codes in the first font of the two font objects, but not to apply the same offset in the second of the two font objects (e.g., instead apply a different offset, or apply no offset at all).

The method 400 may include fewer, alternate, or additional actions, including any suitable actions described in this detailed description. Furthermore, in some embodiments, actions in the method 400 may differ from the order depicted in FIGS. 4A-4C. In some embodiments, one action may be separated into two or more actions. In some embodiments, two or more actions depicted separately in FIGS. 4A-4C may be combined.

### Example Computing Environment for Pdf Text Extraction

FIG. 6 depicts an example computing environment 600 that may be operable to perform actions described herein. Elements of the computing environment 600 may operate, for example, to perform one or more actions of the method 400 depicted in FIGS. 4A-4C. The computing environment 600 may include additional, fewer, or alternate elements to those depicted in FIG. 6, in some embodiments.

At a high level, the computing environment includes a computing device 602 (i.e., one or more computing devices) and a computing network 604 (i.e., one or more networks). The computing device 602 may include for example, a desktop computer, laptop computer, server, smartphone, tablet, or other suitable computing device. The network 604 may include one or wired networks (e.g., wired Local Area Network (LAN)) and/or one or more wireless networks (e.g., wireless LAN or the Internet), and may comprise one or more public and/or private networks using any suitable one or more communications protocols. The computing device 602 may be communicatively connected to the network 604 via one or more wired and/or wireless communicative connections (e.g., hardwired connection(s) and/or IEEE 802.11 communicative connection(s)). The network 604 may be communicatively connected to one or more further computing devices not depicted in FIG. 6.

More particularly, as depicted in FIG. 6, the computing device 602 may communicate via the network 604 to exchange PDF documents, portions of PDF documents, and/or other digital file data (e.g., font encoding data, extracted text content data, and/or other digital data described herein). The computing device 602 may communicate over the network 604 via a network interface 608 (i.e., one or more network interfaces), which may be linked via a communications bus 614 to a computer memory 620 (i.e., one or more computer memories), a computer processor 624 (i.e., one or more computer processors), and/or an input/output (I/O) device 628 (i.e., one or more I/O devices).

The computer memory 620 may include one or more non-transitory computer memories (e.g., ROM, PROM, flash memory, etc.) and/or one or more transitory computer memories (e.g., RAM). The one or more non-transitory computer memories may store non-transitory computer-executable instructions that, when executed via the processor 624, cause the computing device 624 to perform actions described herein via the processor 624. In some embodiments, for example, the non-transitory computer-executable instructions may comprise instructions to execute, at the computing device 602, at least some actions of the method 400 of FIGS. 4A-AC. The computer memory 620 may store one or more computer applications, such as a “PDF Application” 632, which in some embodiments may be configured to perform at least some of the actions described herein.

In some embodiments, the I/O device 628 may interface with one or more suitable auxiliary storage devices 640 (e.g., a USB flash drive, CD-ROM, and/or another non-transitory computer-readable medium), which may store non-transitory computer executable instructions that, when executed via the computing device 602, cause the computing device 602 to perform at least some of the actions described herein (e.g., one or more actions of the method 400 of FIGS. 4A-4C).

In some embodiments, actions described in this detailed description may be distributed across two or more computing devices in the environment 600. For example, in some embodiments, the application 632 at computing device 602 may identify and apply an offset to a font encoding of a PDF document, and may transmit, via the network 604 at least one of (1) an indicator of the appropriate offset for the font encoding, (2) modified font encoding data and/or additional mapping information, or (3) an entire PDF document comprising modified font encoding data and/or additional mapping information. In some embodiments, the computing device 602 may be a dedicated computing device configured to determine offsets and/or modify PDF document font encodings, and may transmit modified documents over the network 604 to one or more further computing devices configured to extract text content from the modified PDF documents.

Various other arrangements of actions of the computing system 600 are possible, in accordance with other possible embodiments.

### ADDITIONAL CONSIDERATIONS

It should be noted that, in the field of digital typography, the term “font” is sometimes used interchangeably with the term “typeface.” A typeface typically refers to a family of fonts sharing common design features, with each font representing a particular style of the typeface (e.g., a particular size, weight, slope, etc.) of the typeface. For example, an Arial typeface may include fonts such as Arial [Regular], Arial Black, and Arial Narrow. Two or more fonts of same typeface may share substantially similar encodings, if not identical font encodings. Accordingly, the term “font” may refer to one particular style of a typeface. It should be understood, though, that the techniques described herein may be applied to two or more fonts in a typeface. In some embodiments, a determined offset of an encoding of a particular font may be applied to each of two or more similarly encoded fonts of a same typeface.

Throughout this detailed description, Unicode character codes or “code points” are provided in a standard Unicode hexadecimal notation of “U+XXXX”, in which “U+” indicates Unicode notation and “XXXX” may be any combination of four hexadecimal digits (0-9, A-F). Differences in notation aside, a hexadecimal glyph code in a font encoding is described herein as “equal to,” “matching,” or “corresponding to” a Unicode character code when the hexadecimal values are numerically equivalent. For example, a hexadecimal code 0x1C may be described as equal to a Unicode character code U+001C. Unicode character encoding, as described herein, may include any suitable Unicode character encoding format, including but not limited to UTF-32 encoding, UTF-16 encoding, and UTF-8 encoding.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still cooperate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition “A or B” is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

This detailed description is to be construed as examples and does not describe every possible embodiment, as describing every possible embodiment would be impractical, if not impossible. One could implement numerous alternate embodiments, using either current technology or technology developed after the filing date of this application.

What is claimed:

1. A computer-implemented method for facilitating text content extraction from a digital document, the method comprising:
identifying, via one or more processors, a font object corresponding to a content stream of a digital document, the font object comprising a font encoding of a plurality of glyph codes to a respective plurality of glyphs;
determining, via the one or more processors, one or more characteristics of one or more glyphs of the font object, the one or more characteristics excluding text information content of the one or more glyphs; and
determining, via the one or more processors based upon the one or more determined glyph characteristics, an integer offset associated with the font encoding,
wherein, for each particular glyph code of the plurality of glyph codes in the font encoding, adding the integer offset to the particular glyph code produces a respective sum value corresponding to a respective Unicode character, the Unicode character being a character represented by the glyph encoded at the particular glyph code of the font encoding.

2. The computer-implemented method of claim 1, wherein the digital document is Portable Document Format (PDF) document.

3. The computer-implemented method of claim 1, further comprising adding, via the one or more processors, the integer offset to each glyph code in the font encoding to produce the respective sum values corresponding to the respective Unicode characters.

4. The computer-implemented method of claim 3, further comprising:
creating, via the one or more processors, a mapping object comprising, for each particular glyph code of the plurality of glyph codes of the font encoding, an indicator of the respective sum value corresponding to the particular glyph code; and
modifying, via the one or more processors, the digital document to include the created mapping object.

5. The computer-implemented method of claim 3, further comprising:
modifying, via the one or more processors, the font object of the digital document, wherein modifying the font object includes, for each particular glyph code of the plurality of glyph codes, replacing the glyph code with the respective sum value corresponding to the respective Unicode character; and
modifying, via the one or more processors, the content stream of the digital document, wherein modifying the content stream includes, for each instance of a glyph code in the content stream, replacing the content stream glyph code with the respective sum value corresponding to the respective Unicode character.

6. The computer-implemented method of claim 1, wherein determining the integer offset includes determining the offset having a hexadecimal value of 0x1D.

7. The computer-implemented method of claim 1, wherein determining the integer offset includes determining the offset having a hexadecimal value of 0x1E.

8. The computer-implemented method of claim 1, further comprising:
for each of one or more glyph codes in the content stream of the digital document, adding, via the one or more processors, the offset to the content stream glyph code to produce a respective content stream sum value; and
determining, via the one or more processors, based upon the one or more respective content stream sum values, one or more corresponding Unicode characters to thereby extract the text content of the content stream.

9. The computer-implemented method of claim 3, further comprising:
for each of one or more glyph codes in the content stream of the digital document, referencing, via the one or more processors, the created mapping object to identify a respective mapped value corresponding to the content stream glyph code; and
determining, via the one or more processors, based upon the one or more respective content stream mapped values, one or more corresponding Unicode characters to thereby extract the text content of the content stream.

10. The computer-implemented method of claim 1, wherein determining the one or more the one or more glyph characteristics comprises determining a width of one or more glyphs of the font object.

11. The computer-implemented method of claim 1, wherein determining the one or more glyph characteristics comprises determining whether a glyph of the font object is set, based at least in part upon at least one of (1) a comparison of a width of the glyph to a default width of the font object, or (2) a comparison of the width of the glyph to a predicted space width of the font object.

12. A computing system configured to facilitate text content extraction from a digital document, the computing system comprising:
one or more processors; and
one or more non-transitory computer memories storing computer-executable instructions that, when executed via the one or more processors, cause the one or more processors to:
identify a font object corresponding to a content stream of a digital document, the font object comprising a font encoding of a plurality of glyph codes to a respective plurality of glyphs,
determine one or more characteristics of one or more glyphs of the font object, the one or more characteristics excluding text information content of the one or more glyphs, and
determine, based upon the one or more determined characteristics of the one or more glyphs, an integer offset associated with the font encoding,
wherein, for each particular glyph code of the plurality of glyph codes in the font encoding, adding the integer offset to the particular glyph code produces a respective sum value corresponding to a respective Unicode character, the Unicode character being a character represented by the glyph encoded at the particular glyph code of the font encoding.

13. The computing system of claim 12, wherein the digital document is a PDF document.

14. The computing system of claim 12, wherein the computer-executable instructions further include instructions that, when executed via the one or more processors, cause the one or more processors to:
add the integer offset to each glyph code in the font encoding to produce the respective sum values corresponding to the respective Unicode characters.

15. The computing system of claim 14, wherein the computer-executable instructions further include instructions that, when executed via the one or more processors, cause the one or more processors to:
create a mapping object comprising, for each particular glyph code of the plurality of glyph codes of the font encoding, an indicator of the respective sum value corresponding to the particular glyph code; and
modify the digital document to include the created mapping object.

16. The computing system of claim 14, wherein the computer-executable instructions further include instructions that, when executed via the one or more processors, cause the one or more processors to:
modify the font object of the digital document, wherein modifying the font object includes, for each particular glyph code of the plurality of glyph codes, replacing the glyph code with the respective sum value corresponding to the respective Unicode character; and
modify the content stream of the digital document, wherein modifying the content stream includes, for each instance of a glyph code in the content stream, replacing the content stream glyph code with the respective sum value corresponding to the respective Unicode character.

17. The computing system of claim 12, wherein the determined integer offset has a hexadecimal value of 0x1D.

18. The computing system of claim 12, wherein the determined integer offset has a hexadecimal value of 0x1E.

19. The computing system of claim 12, wherein the computer-executable instructions further include instructions that, when executed via the one or more processors, cause the one or more processors to:
for each of one or more glyph codes in the content stream of the digital document, add the offset to the content stream glyph code to produce a respective content stream sum value; and
determining, based upon the one or more respective content stream sum values, one or more corresponding Unicode characters to thereby extract the text content of the content stream.

20. One or more non-transitory computer-readable media storing computer-executable instructions that, when executed via a computer, cause the computer to:
identify a font object corresponding to a content stream of a digital document, the font object comprising a font encoding of a plurality of glyph codes to a respective plurality of glyphs,
determine one or more characteristics of one or more glyphs of the font object, the one or more characteristics excluding text information content of the one or more glyphs, and
determine, based upon the one or more determined characteristics of the one or more glyphs, an integer offset associated with the font encoding,
wherein, for each particular glyph code of the plurality of glyph codes in the font encoding, adding the integer offset to the particular glyph code produces a respective sum value corresponding to a respective Unicode character, the Unicode character being a character represented by the glyph encoded at the particular glyph code of the font encoding.
